(19) United States
(12) Patent Application Publication
(10) Pub. No.: US 2025/0106549 A1
(43) Pub. Date: Mar. 27, 2025

(54) AIR ADSORBENTS FOR MICRO SPEAKER INCLUDING HYDROPHOBIC METAL-ORGANIC FRAMEWORK AND SPEAKER BOX SYSTEM INCLUDING THE SAME

(71) Applicant: NEXVEL CO., LTD, Yongin-si (KR)

(72) Inventors: Dae Lyun KANG, Suwon-si (KR); Seung Chan LEE, Gwangju-si (KR)

(73) Assignee: NEXVEL CO., LTD, Yongin-si (KR)

(21) Appl. No.: 18/893,971

(22) Filed: Sep. 24, 2024

(30) Foreign Application Priority Data
Sep. 27, 2023 (KR) 10-2023-0130317

(51) Int. Cl. H04R 1/28; B01J 20/22; B01J 20/28

(52) U.S. Cl. CPC H04R 1/2811; B01J 20/226; B01J 20/28026; B01J 20/2803; B01J 20/28064; B01J 20/28066; B01J 20/2808; B01J 20/28083

(57) ABSTRACT

The present invention relates to an air adsorbent for a micro speaker including a hydrophobic metal-organic framework, and a speaker box system including the same, wherein the air adsorbent for a micro speaker according to an embodiment of the present invention includes a metal-organic framework (MOF) and has hydrophobic properties.

### CROSS-REFERENCE TO RELATED APPLICATION

This application claims priority to Korean Patent Application No. 10-2023-0130317 filed on Sep. 27, 2023, and all the benefits accruing therefrom under 35 U.S.C. § 119, the contents of which are incorporated by reference in their entirety.

### BACKGROUND

The present disclosure relates to an air adsorbent for a micro speaker including a hydrophobic metal-organic framework, and a speaker box system including the same.

Micro speaker-box systems for smartphones are now equipped with a sound resonance space as a sound resonance chamber in a certain part of a speaker-box module, which houses a core speaker, to deliver rich bass even in compact sizes. In particular, for micro speakers designed to be compact, sound resonance spaces make a significant contribution to low-frequency sound characteristics; larger resonance spaces contribute to better low-end reproduction and wider frequency response.

Unfortunately, smartphones are limited when it comes to significantly increasing the volume of the sound resonance space due to design constraints such as size, shape, and speaker sound outlet placement. To compensate for this limitation, a range of air adsorbents are introduced into the limited sound resonance space, leveraging the adsorption and desorption of air molecules from sound propagation, thus obtaining an expanded volume of the resonance space through a virtual back volume.

However, with the ongoing price reduction of products like smartphones, there is a pressing need to reduce the cost of components such as micro speaker-boxes. To this end, there is a demand for a new air adsorbent that brings cost savings and matches or exceeds the acoustic performance of typical air adsorbents formed from porous zeolite granules or porous activated carbon fibers in the form of woven fabric sheets.

### RELATED ART DOCUMENT

### Patent Document

(Patent Document 1) Korean Patent Registration No. 10-2155642

### SUMMARY

The present disclosure provides an air adsorbent for a micro speaker exhibiting excellent compression strength and durability, and a speaker box system including the same.

In an embodiment of the present invention, a hydrophobic metal-organic framework exhibiting excellent compression strength, durability, and hydrophobicity may be used to overcome issues such as particle generation caused by wear and breakage of typical zeolite air adsorbents and reduced adsorption performance at high humidity of typical activated carbon air adsorbents.

In addition, the present invention may enhance sound pressure level (SPL) characteristics in the low-frequency range.

In addition, the present invention is hydrophobic, resulting in a long lifespan.

In addition, the present invention may mitigate acoustic noise (THD: Total Harmonic Distortion) characteristics.

In addition, the present invention may allow for an efficient process of disposing an air adsorbent in a speaker box system.

In accordance with an exemplary embodiment of the present invention, an air adsorbent for a micro speaker includes a metal-organic framework (MOF) and has hydrophobic properties.

The metal-organic framework includes a metal ion (metal cluster) and an organic linker disposed around the metal ion to form a three-dimensional coordination bond and may have a cage-like porosity.

The metal-organic framework may include a hydrophobic functional group.

A metal ion contained in the metal-organic framework may be any one of zinc (Zn), aluminum (Al), iron (Fe), and zirconium (Zr).

The metal-organic framework may be a zeolitic-imidazolate-framework.

The air adsorbent for a micro speaker may include pores having diameters of 1 nm to 10 nm and have a specific surface area (BET-SSA) of 900 to 4100 m²/g.

The metal-organic framework may be prepared by mixing a metal and an organic linker.

The organic linker may be any one of terephthalic acid, benzene tribenzoate, carboxylic acid, and methylimidazole.

The metal-organic framework may include a metal and an organic linker. In this case, the metal and the organic linker may be present at a molar ratio of 1:2 to 2:1.

An embodiment may further include a binder.

The binder may be any one of polyvinyl chloride (PVC), polyethylene (PE), polyoxymethylene (POM), polycarbonate chain (PC), ethylene-propylene copolymer (EPDM), polyvinylidene chloride (PVDC), polyvinyl alcohol (PVA), polyvinyl butyral (PVB), cellulose acetate (CA), polypropylene (PP), polymethyl methacrylate (PMMA), polyamide (PA), tetrafluoroethylene/hexafluoropropylene copolymer (FEP), polytetrafluoroethylene (PTFE), phenol formaldehyde (PF), epoxide (EP), polyurethane (PUR), and polyester (UP).

Another embodiment may further include a matrix structure.

The metal-organic framework may be dispersed and disposed inside and outside the matrix structure.

The metal-organic framework may be disposed in the matrix structure through an impregnation process.

In accordance with another exemplary embodiment of the present invention, a speaker box system includes the air adsorbent for a micro speaker described above.

### BRIEF DESCRIPTION OF THE DRAWINGS

Exemplary embodiments can be understood in more detail from the following description taken in conjunction with the accompanying drawings, in which:

FIG. 1 shows a speaker box system according to an embodiment of the present invention;

FIG. 2 is a molecular structure formula of a metal-organic framework;

FIG. 3 shows water vapor adsorption characteristics of hydrophobic MOFs under high humidity conditions according to an embodiment of the present invention;

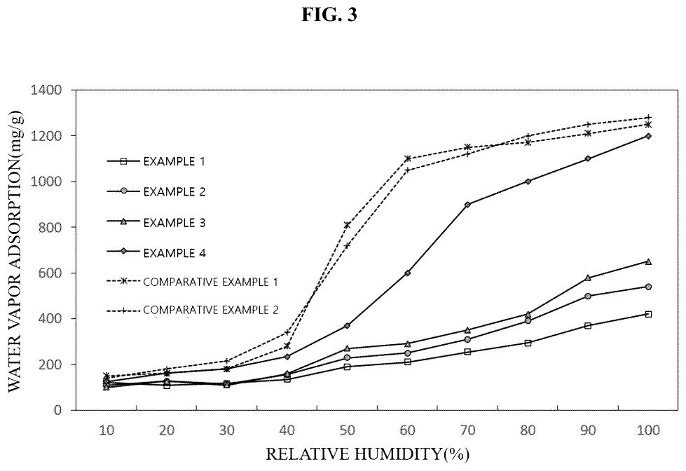

FIG. 4 shows the measured impedance of a speaker box system as a function of frequency; and

FIG. 5 shows the measured sound pressure level (SPL) of a speaker box system as a function of frequency.

### DETAILED DESCRIPTION OF EMBODIMENTS

Hereinafter, preferred embodiments of the present invention will be described as follows with reference to the accompanying drawings. The invention may, however, be embodied in many different forms and should not be construed as being limited to the embodiments set forth herein. In addition, these embodiments of the present invention are provided so that the present invention will be thorough and complete, and will fully convey the scope of the invention to those skilled in the art. Therefore, in the drawings, the shapes and dimensions of elements may be exaggerated for clarity, and the same reference numerals will be used throughout to designate the same or like elements. The same symbol will be used for elements implementing similar functions and operations in entire drawings. Moreover, throughout the entire description of the present invention, when one part is said to “include (or comprise)” an element, unless specifically mentioned otherwise, instead of excluding any other element, this may signify that the one part may further include other elements.

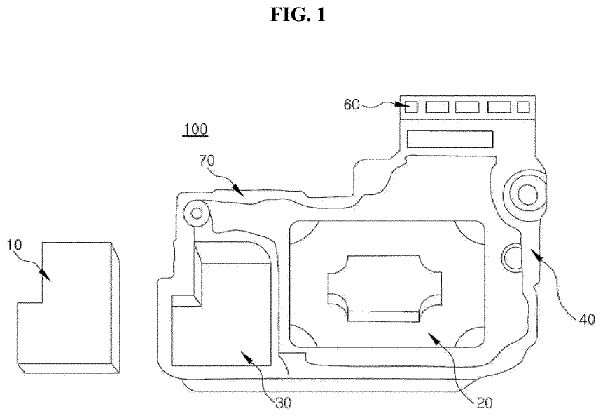

FIG. 1 shows a speaker box system 100 according to an embodiment of the present invention. Referring to FIG. 1, the speaker box system 100 according to an embodiment of the present invention includes the air adsorbent for a micro speaker described above.

The speaker box system 100 may be a speaker module used in small electronic devices such as smartphones and laptops. More specifically, the speaker box system may include a housing 40, a micro speaker 20 generating sound, a sound outlet 60 emitting sound, a sound resonance space 30 resonating emitted sound to improve sound quality, a micro speaker voice coil connection PCB 70 including an electronic circuit for driving the speaker, and an air adsorbent 10 disposed in the sound resonance space.

The speaker box system 100, a system including the speaker 20 in a box or the housing 40, may resonate and emit sound generated from a speaker in the sound resonance space 30 inside the box or housing 40, thereby reducing sound interference and improving sound quality and volume. In particular, the sound resonance space 30 is critical in terms of acoustic characteristics of the low-frequency range; an increase in the sound resonance space allows for better sound reproduction in the low-frequency range and wider frequency response. The air adsorbent 10 may be disposed in the sound resonance space 30 of the speaker box system 100 to further improve the acoustic characteristics of the low-frequency range. In this case, the low-frequency range may indicate a range of 1000 Hz or below and preferably may indicate a frequency range of 200 to 800 Hz. The air adsorbent 10 may create a virtual back volume, i.e., a virtual sound resonance space, through the adsorption and desorption of air molecules, and thus may exhibit a volume expansion effect that expands the physically limited sound resonance space 30. In addition, this may improve the acoustic characteristics of the low-frequency range of the speaker box system 100 and widen the frequency response.

The housing 40, the micro speaker 20, the sound resonance space 30, the sound outlet 60, and the micro speaker voice coil connection PCB may be those commonly used in the art and are not particularly limited.

In the present invention, the air adsorbent includes a metal-organic framework (MOF) and has hydrophobic properties.

The present invention may be composed of the metal-organic framework itself and may be mixed with another object, for example, a binder such as a polymer resin, or may be a metal-organic framework dispersed and disposed in a two-dimensional matrix structure. The metal-organic framework may have various three-dimensional shapes, including powder forms such as spherical, plate-like, rod-like, polyhedral, and irregular shapes, or wire, sheet, or film forms.

The metal-organic framework (MOF) indicates a porous material in which metal is connected through an organic linker. The metal-organic framework is a structure having a large number of pores and may adsorb gases such as air and water vapor. Utilizing these characteristics, the metal-organic framework may be disposed in a sound resonance space of a speaker box system to adsorb and desorb air, and thus may be used as an air adsorbent for a speaker box system.

However, most metal-organic frameworks that are usable as an air adsorbent for a speaker box system exhibit hydrophilicity and thus adsorb moisture from the air, but fail to adsorb air in humid conditions, resulting in a substantial reduction in the expansion of the sound resonance space of the speaker box system. The present invention overcomes this issue by using a metal-organic framework containing a hydrophobic functional group.

The hydrophobic functional group may be an alkyl chain such as methyl (—CH₃) or ethyl (—CH₂CH₃), an aromatic chain such as benzene (C₆H₅), a halogen chain such as chlorine, bromine, or iodine, an ether chain such as R—O—R′, and may also include functional groups such as —CF₃ or —SiR₃.

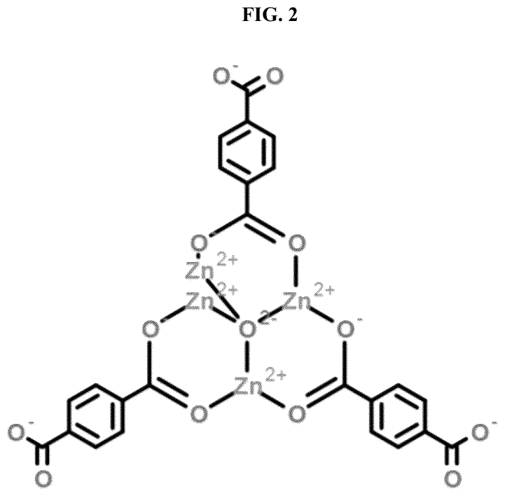

In addition, the metal-organic framework may be determined to have hydrophobicity or hydrophilicity depending on the type of central metal ion. In the present invention, a metal ion contained in the metal-organic framework may be any one of zinc (Zn), aluminum (Al), iron (Fe), and zirconium (Zr), and may preferably be zinc. In an embodiment, the metal-organic framework may be represented by Molecular Formula 1 and FIG. 2 below.

C₂₄H₁₂0₁₃Zn₄ [Molecular Formula 1]

The metal-organic framework may be a zeolitic-imidazolate-framework, which is ZIF-8(Zn). The ZIF-8(Zn) may be prepared through a solvothermal method, has a large specific surface area, and is structurally stable. In addition, the ZIF-8(Zn) has hydrophobicity, a contact angle of 79.6 degrees, and low conductivity. The ZIF-8(Zn) is a metal-organic framework having zinc (Zn²⁺) as a central metal and 2-methylimidazolle as an organic ligand (C₄H₆N₂⁻). The ZIF-8(Zn) may be represented by Molecular Formula 2 below.

C₄H₆N₂Zn [Molecular Formula 2]

The metal-organic framework included in the present invention may include pores having diameters of 1 nm to 10 nm, and have a micro-pore volume of 0.25 to 0.40 cc/g and a specific surface area (BET-SSA) of 900 to 4100 m²/g. Accordingly, the metal-organic framework may effectively adsorb and desorb air.

Hereinafter, a method for preparing a hydrophobic metal-organic framework is described.

The method for preparing a metal-organic framework may include dissolving a metal and an organic linker in a solvent, preparing a metal-organic framework through a solvothermal method, and obtaining the metal-organic framework.

In the process of dissolving, the solvent may be an organic solvent such as dimethylformamide, ether, acetone, or alcohol, and is not particularly limited.

The metal may be any one of zinc (Zn), aluminum (Al), iron (Fe), and zirconium (Zr), and may preferably be zinc, as described above.

The organic linker may be any one of terephthalic acid, benzene tribenzoate, carboxylic acid, and methylimidazole, and may preferably be terephthalic acid.

In this case, the metal and the organic linker may be present at a molar ratio of 1:2 to 2:1. The metal-organic framework is prepared most efficiently in the range described above.

In the preparing of the metal-organic framework, the solvothermal method may be performed by various methods performed in the art to prepare a synthetic material and is not particularly limited. In an embodiment, the method involves dropping the mixed solution dropwise at a constant temperature.

The obtaining of the metal-organic framework involves cooling, filtering, and drying the metal-organic framework prepared through the solvothermal method. The cooling, filtering, and drying processes may be commonly performed in the art.

An embodiment may further include a binder together with the metal-organic framework. The metal-organic framework may be dispersed and disposed inside and outside the binder. Accordingly, even when a hydrophilic metal-organic framework is used, an air adsorbent having overall hydrophobicity may be prepared. In addition, the metal-organic framework may be prepared in the form of a sheet or film, enabling more convenient supply of the air adsorbent.

The binder may be any one of polyvinyl chloride (PVC), polyethylene (PE), polyoxymethylene (POM), polycarbonate chain (PC), ethylene-propylene copolymer (EPDM), polyvinylidene chloride (PVDC), polyvinyl alcohol (PVA), polyvinyl butyral (PVB), cellulose acetate (CA), polypropylene (PP), polymethyl methacrylate (PMMA), polyamide (PA), tetrafluoroethylene/hexafluoropropylene copolymer (FEP), polytetrafluoroethylene (PTFE), phenol formaldehyde (PF), epoxide (EP), polyurethane (PUR), and polyester (UP).

Another embodiment may further include a matrix structure together with the metal-organic framework. In this case, the metal-organic framework may be dispersed and disposed inside and outside the matrix structure. Accordingly, even when a hydrophilic metal-organic framework is used, an air adsorbent having overall hydrophobicity may be prepared. In addition, the metal-organic framework may be prepared in the form of a sheet or film, enabling a more convenient supply of the air adsorbent.

The matrix structure is a structure having a three-dimensional skeletal shape, which may be a non-woven fabric or felt. The matrix structure may be made of a polymer resin and may be, for example, at least any one of polyvinyl chloride (PVC), polyethylene (PE), polyoxymethylene (POM), polycarbonate chain (PC), ethylene-propylene copolymer (EPDM), polyvinylidene chloride (PVDC), polyvinyl alcohol (PVA), polyvinyl butyral (PVB), cellulose acetate (CA), polypropylene (PP), polymethyl methacrylate (PMMA), polyacrylate (PA), tetrafluoroethylene/hexafluoropropylene copolymer (FEP), polytetrafluoroethylene (PTFE), phenol formaldehyde (PF), epoxide (EP), polyurethane (PUR), or polyester (UP).

In an embodiment, the metal-organic framework may be disposed in the matrix structure through an impregnation process.

### Preparation Example 1: Preparation of Metal-Organic Frameworks

Example 1: Zinc nitrate was prepared as a metal precursor and terephthalic acid was prepared as an organic linker. 5.95 g (0.02 mol) of zinc nitrate was dissolved in 200 ml of distilled water and 9.90 g (0.06 mol) of terephthalic acid was dissolved in 200 ml of dimethylformamide (DMF), and then a certain amount of dimethylformamide solution was put into a stainless steel reactor lined with polytetrafluoroethylene (PTFE) as base fluid, and the zinc nitrate solution dissolved in distilled water and the terephthalic acid solution dissolved in dimethylformamide were dropped from above. In this case, the dimethylformamide solution was heated and stirred at 140° C. for 12 hours, and the zinc nitrate solution was dropped at 50 ml per minute and the terephthalic acid solution was dropped at 40 ml per minute. Thereafter, the resulting product was dried in an oven at 110° C. Lastly, the resulting product was filtered, washed, and dried to obtain a metal-organic framework having a particle diameter of 0.1 to 5 m and a central metal of zinc (Zn).

Example 2: A process was performed in the same manner as in Example 1, except that the solvothermal process was performed at 120° C. instead of 140° C.

Example 3: A process was performed in the same manner as in Example 1, except that the solvothermal process was performed at 160° C. instead of 140° C.

Example 4: A metal-organic framework was prepared in the same manner as in Example 1, except that iron chloride was used as a metal precursor and a central metal was iron (Fe).

Comparative Example 1: A metal-organic framework was prepared in the same manner as in Example 1, except that aluminum was used as a metal precursor and a central metal was aluminum (Al).

Comparative Example 2: A metal-organic framework was prepared in the same manner as in Example 1, except that copper sulfate was used as a metal precursor and a central metal was copper (Cu).

### Experimental Example 1

Micropore size, specific surface area, and contact angle for water were measured using Examples and Comparative Examples. The micropore size was measured using a scanning electron microscope (SEM), the specific surface area was measured using a Brunauer, Emmett and Teller-Specific Surface Area (BET-SSA) test device, and the hygroscopicity was measured as the surface contact angle through water droplets falling.

The results are shown in Table 1 below.

TABLE 1

| | | Solvothermal | | | | |
|---|---|---|---|---|---|---|
| | | process | Micropore | Specific surface | | |
| | Central | temperature | size | area (BET-SSA) | Contact angle | |
| Item | metal | [° C.] | [nm] | [m²/g] | [deg] | Hygroscopicity |
| Example 1 | Zinc (Zn) | 140 | 1.2 | 1850 | 160 | Hydrophobicity |
| Example 2 | Zinc (Zn) | 120 | 1.6 | 1200 | 170 | Hydrophobicity |
| Example 3 | Zinc (Zn) | 160 | 2.9 | 1050 | 150 | Hydrophobicity |
| Example 4 | Iron(Fe) | 140 | 2.5 | 1150 | 120 | Hydrophobicity |
| Comparative | Aluminum | 140 | 1.7 | 1100 | 7 | Hydrophilicity |
| Example 1 | (Al) | | | | | |
| Comparative | Copper | 140 | 3.2 | 930 | 8 | Hydrophilicity |
| Example 2 | (Cu) | | | | | |

Referring to Table 1, materials were determined to be hydrophobic and have a large specific surface area when the central metals were zinc and iron. In particular, Example 1, where the central metal was zinc, had the smallest micropores, the largest specific surface area, and the strongest hydrophobic properties.

### Preparation Example 2: Manufacturing of Sheet-Type Air Adsorbent Using Nonwoven Fabric

Example 5: 100 g of the metal-organic framework powder prepared in Example 1 was dispersed in 3 L of distilled water, impregnated into a 0.65 mm thick nonwoven fabric made of polypropylene, and then dried to manufacture a sheet-type air adsorbent. The sheet-type air adsorbent had a size of 11.5 mm×9.5 mm×0.65 mm (width×length×height).

### Preparation Example 3: Manufacturing of Speaker Box Systems

Example 6: One sheet of the air adsorbent manufactured in Example 5 was put into a sound resonance space of a speaker box system, having a sound resonance space size of 15 mm×12 mm×5.5 mm (width×length×height), a volume of approximately 1 cc, a nominal impedance of 6Ω, and a driving voltage of 1 V, to manufacture a speaker box system.

Example 7: A speaker box system was manufactured in the same manner as in Example 1, except that two sheets of the air adsorbent from Example 5 were placed in the sound resonance space.

Example 8: A speaker box system was manufactured in the same manner as in Example 1, except that three sheets of the air adsorbent from Example 5 were placed in the sound resonance space.

Example 9: A speaker box system was manufactured in the same manner as in Example 1, except that four sheets of the air adsorbent from Example 5 were placed in the sound resonance space.

Example 10: A speaker box system was manufactured in the same manner as in Example 1, except that five sheets of the air adsorbent from Example 5 were placed in the sound resonance space.

Comparative Example 3: A speaker box system without an air adsorbent was prepared.

### Experimental Example 2

Impedance and air adsorption performance of Examples 6 to 10 and Comparative Example 3 were measured through an impedance measurement method according to speaker driving voltage frequency and a sound pressure level measurement method according to speak frequency.

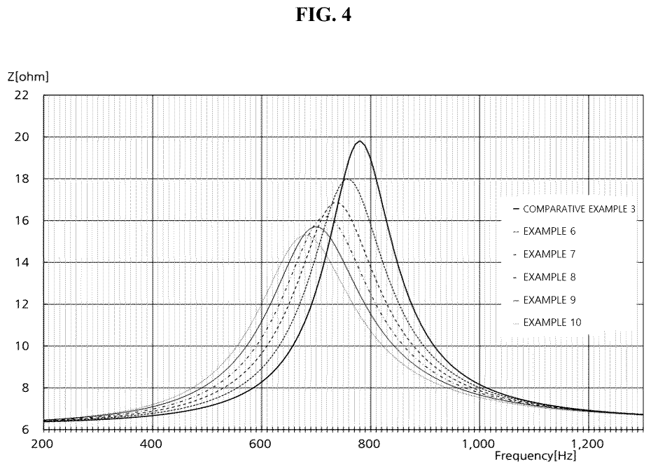

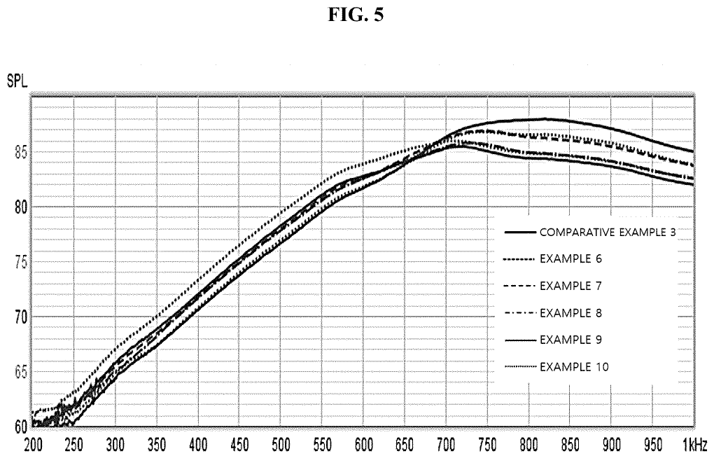

The results are shown in Table 2, FIG. 4, and FIG. 5 below.

TABLE 2

| | Quantity of | | | |
|---|---|---|---|---|
| | air adsorbent | | | Air |
| | [unit] | | Impedance | adsorption |
| | (1 unit size: | | results | performance |
| | 11.5 mm × | Volume of | (resonant | (resonant |
| | 9.5 mm × | air adsorbent | frequency) | frequency |
| Item | 0.65 mm) | [cc] | [Hz] | shift) [Hz] |
| Example 6 | 1 | 0.071 | 759.494 | −19.727 |
| Example 7 | 2 | 0.142 | 735.294 | −43.927 |
| Example 8 | 3 | 0.213 | 721.154 | −58.067 |
| Example 9 | 4 | 0.284 | 697.348 | −81.873 |
| Example 10 | 5 | 0.355 | 679.348 | −99.873 |
| Comparative | 0 | 0 | 779.221 | 0 |
| Example 3 | | | | |

Referring to FIG. 4, it was found that the resonance frequency (Fo) shifted towards lower frequencies as the number of stacked air adsorbents increased. In addition, referring to FIG. 5, it was found that a maximum increase in SPL value was observed in the low-frequency range of 200 to 800 Hz as the number of stacked intake elements increased.

### Preparation Example 4: Manufacturing of Sheet-Type Air Adsorbent Using Binder

Example 11: 100 g of the metal organic framework powder prepared in Example 1 and 20 g of polyacrylate (PA) as an organic binder were mixed in 0.2 L of dimethylformamide, kneaded, placed in a mold, and pressed to form a shape. Then, the resulting product was dried at 120° C. to form a sheet. The manufactured sheet-type air adsorbent had a size of 11.5 mm×9.5 mm×0.5 mm (width×length×height).

Example 12: A sheet-type air adsorbent was manufactured in the same manner as in Example 11, except that the manufactured sheet-type air adsorbent had a size of 11.5 mm×9.5 mm×0.65 mm (width×length×height).

Example 13: A sheet-type air adsorbent was manufactured in the same manner as in Example 11, except that the manufactured sheet-type air adsorbent had a size of 11.5 mm×9.5 mm×0.85 mm (width×length×height).

Example 14: A sheet-type air adsorbent was manufactured in the same manner as in Example 11, except that the manufactured sheet-type air adsorbent had a size of 11.5 mm×9.5 mm×1.00 mm (width×length×height).

Example 15: A sheet-type air adsorbent was manufactured in the same manner as in Example 11, except that the manufactured sheet-type air adsorbent had a size of 11.5 mm×9.5 mm×1.25 mm (width×length×height).

Example 16: A sheet-type air adsorbent was manufactured in the same manner as in Example 11, except that the manufactured sheet-type air adsorbent had a size of 11.5 mm×9.5 mm×1.50 mm (width×length×height).

Example 17: A sheet-type air adsorbent was manufactured in the same manner as in Example 11, except that the manufactured sheet-type air adsorbent had a size of 11.5 mm×9.5 mm×1.85 mm (width×length×height).

Example 18: A sheet-type air adsorbent was manufactured in the same manner as in Example 11, except that the manufactured sheet-type air adsorbent had a size of 11.5 mm×9.5 mm×2.00 mm (width×length×height).

Example 19: A sheet-type air adsorbent was manufactured in the same manner as in Example 11, except that the manufactured sheet-type air adsorbent had a size of 11.5 mm×9.5 mm×2.35 mm (width×length×height).

### Preparation Example 5: Manufacturing of Speaker Box Systems

Example 20: The air adsorbent manufactured in Example 11 was put into a sound resonance space of a speaker box system, having a sound resonance space size of 15 mm×12 mm×2.5 mm (width×length×height), a volume of approximately 0.45 cc, a nominal impedance of 6Ω, and a driving voltage of 1 V, to manufacture a speaker box system.

Example 21: A speaker box system was manufactured in the same manner as in Example 20, except that the air adsorbent manufactured in Example 12 was used.

Example 22: A speaker box system was manufactured in the same manner as in Example 20, except that the air adsorbent manufactured in Example 13 was used.

Example 23: A speaker box system was manufactured in the same manner as in Example 20, except that the air adsorbent manufactured in Example 14 was used.

Example 24: A speaker box system was manufactured in the same manner as in Example 20, except that the air adsorbent manufactured in Example 15 was used.

Example 25: A speaker box system was manufactured in the same manner as in Example 20, except that the air adsorbent manufactured in Example 16 was used.

Example 26: A speaker box system was manufactured in the same manner as in Example 20, except that the air adsorbent manufactured in Example 17 was used.

Example 27: A speaker box system was manufactured in the same manner as in Example 20, except that the air adsorbent manufactured in Example 18 was used.

Example 28: A speaker box system was manufactured in the same manner as in Example 20, except that the air adsorbent manufactured in Example 19 was used.

Comparative Example 4: A speaker box system without an air adsorbent was prepared.

### Experimental Example 3

Impedance and air adsorption performance of Examples 20 to 28 and Comparative Example 4 were measured through an impedance measurement method according to speaker driving voltage frequency and a sound pressure level measurement method according to speaker frequency.

The results are shown in Table 3 below.

TABLE 3

| | Thickness of | | | |
|---|---|---|---|---|
| | air adsorbent | | | Air adsorption |
| | [mm] | | Impedance | performance |
| | (Size of air | | results | (resonant |
| | adsorbent: | Volume of | (resonant | frequency |
| | 11.5 mm × 9.5 | air adsorbent | frequency) | shift) |
| Item | mm) | [cc] | [Hz] | [Hz] |
| Example 20 | 0.50 | 0.0546 | 968.615 | 12.597 |
| Example 21 | 0.65 | 0.071 | 956.251 | 24.961 |
| Example 22 | 0.85 | 0.0928 | 942.137 | 39.075 |
| Example 23 | 1.00 | 0.1092 | 929.728 | 51.484 |
| Example 24 | 1.25 | 0.1365 | 916.576 | 64.636 |
| Example 25 | 1.50 | 0.1638 | 902.982 | 78.23 |
| Example 26 | 1.85 | 0.2021 | 893.472 | 87.74 |
| Example 27 | 2.00 | 0.2185 | 883.871 | 97.341 |
| Example 28 | 2.35 | 0.2567 | 885.357 | 99.669 |
| Comparative | 0 | 0 | 981.212 | 0 |
| Example 4 | | | | |

Referring to Table 3, it may be seen that when the air adsorbent had a thickness of 2.00 mm or more, no further improvement in air adsorption performance was observed, indicating saturation. This may be understood as being caused by the deterioration of airflow in the sound resonance space due to the air adsorbent sheet.

### Preparation Example 6: Preparation of Metal-Organic Frameworks (Evaluation of ZIF-8(Zn))

Example 29: 0.4 g of zinc nitrate hexahydrate as a metal salt precursor and 7.4 g of organic 2-methyl imidazole were each dissolved in water, mixed, and left for 24 hours. The mixture was separated using a centrifuge at 4,000 rpm for 30 minutes, and the supernatant was removed. Ethanol was added to thereto, mixed, and then put back into a centrifuge to obtain ZIF-8. Thereafter, the gel-like ZIF-8 was evenly spread on a petri dish, placed in a vacuum oven, and dried for 2 hours to obtain a metal-organic framework.

The ZIF-8(Zn) thus obtained is a white powder particle having a pore size of 1.2 to 2.5 nanometers, a pore volume of 1 to 2 cm³/g, a specific surface area (BET-SSA) of 1,000 to 1,200 m²/g, and a particle size of several hundred nanometers to several micrometers.

Example 30: 100 g of the metal organic framework powder prepared in Example 29 and 20 g of polyacrylate (PA) as an organic binder were mixed in 0.2 L of dimethylformamide, kneaded, placed in a mold, and pressed to form a shape. Then, the resulting product was dried at 120° C. to form a sheet. The manufactured sheet-type air adsorbent had a size of 11.5 mm×9.5 mm×0.5 mm (width×length×height).

Comparative Example 5: 100 g of zeolite (aluminosilicate) powder having a diameter of several micrometers and 20 g of polyacrylate (PA) as an organic binder were mixed in 0.2 L of dimethylformamide, kneaded, placed in a mold, and pressed to form a shape. Then, the resulting product was dried at 120° C. to form a sheet. The manufactured sheet-type air adsorbent had a size of 11.5 mm×9.5 mm×0.5 mm (width×length×height).

### Preparation Example 7: Manufacturing of Speaker Box Systems (Evaluation of ZIF-8(Zn))

Example 31: Four sheets of the sheet-type air adsorbent manufactured in Example 30 were put into a sound resonance space of a speaker box system, having a sound resonance space size of 15 mm×12 mm×2.5 mm (width×length×height), a volume of approximately 0.45 cc, a nominal impedance of 6Ω, and a driving voltage of 1 V, to manufacture a speaker box system.

Comparative Example 6: A speaker box system was manufactured in the same manner as in Example 31, except that four sheets of the zeolite sheet-type air adsorbent manufactured in Example 5 were used.

Comparative Example 7: A speaker box system without an air adsorbent was prepared.

### Experimental Example 4

Impedance and air adsorption performance of Example 31 and Comparative Examples 6 and 7 were measured through an impedance measurement method according to speaker driving voltage frequency and a sound pressure level measurement method according to speaker frequency.

The results are shown in Table 4 below.

TABLE 4

| | | | Air adsorption |
|---|---|---|---|
| | Volume of | Impedance results | performance |
| | air | (resonant | (resonant frequency |
| | adsorbent | frequency) | shift) |
| Item | [cc] | [Hz] | [Hz] |
| Example 31 | 0.2184 | 879.321 | 101.891 |
| Comparative | 0.2184 | 883.565 | 97.647 |
| Example 6 | | | |
| Comparative | 0 | 981.212 | 0 |
| Example 7 | | | |

Referring to Table 4, it is seen that using ZIF-8(Zn) resulted in an equal or better air adsorption performance compared to using zeolite.

An air adsorbent for a micro speaker and a speaker box system including the same, according to an embodiment of the present invention, exhibit excellent compression strength through metal ions and thus have excellent durability.

In addition, the present invention may enhance sound pressure level (SPL) characteristics in the low-frequency range.

In addition, the present invention is hydrophobic and thus is usable even in high-humidity conditions.

In addition, the present invention may mitigate acoustic noise (THD: Total Harmonic Distortion) characteristics.

In addition, the present invention may allow for an efficient process of disposing an air adsorbent in a speaker box system.

The present invention is not limited to the above-described embodiments and the accompanying drawings and is intended to be limited by the appended claims. Accordingly, various forms of substitution, modification, and alteration may be made by those skilled in the art without departing from the technical spirit of the present invention described in the claims, which may be also within the scope of the present invention.

What is claimed is:

1. An air adsorbent for a micro speaker comprising a metal-organic framework (MOF) and having hydrophobic properties.

2. The air adsorbent for a micro speaker of claim 1, wherein the metal-organic framework comprises a hydrophobic functional group.

3. The air adsorbent for a micro speaker of claim 1, wherein a metal ion contained in the metal-organic framework is any one of zinc (Zn), aluminum (Al), iron (Fe), and zirconium (Zr).

4. The air adsorbent for a micro speaker of claim 1, comprising pores having diameters of 1 to 10 nm, and having a specific surface area (BET-SSA) of 900 to 2500 m²/g.

5. The air adsorbent for a micro speaker of claim 1, wherein the metal-organic framework is prepared by mixing a metal and an organic linker, and
the organic linker is any one of terephthalic acid, benzene tribenzoate, carboxylic acid, and methylimidazole.

6. The air adsorbent for a micro speaker of claim 1, wherein the metal-organic framework comprises a metal and an organic linker, and
the metal and the organic linker are present at a molar ratio of 1:2 to 2:1.

7. The air adsorbent for a micro speaker of claim 1, further comprising a binder,
wherein the binder is any one of polyvinyl chloride (PVC), polyethylene (PE), polyoxymethylene (POM), polycarbonate chain (PC), ethylene-propylene copolymer (EPDM), polyvinylidene chloride (PVDC), polyvinyl alcohol (PVA), polyvinyl butyral (PVB), cellulose acetate (CA), polypropylene (PP), polymethyl methacrylate (PMMA), polyamide (PA), tetrafluoroethylene/hexafluoropropylene copolymer (FEP), polytetrafluoroethylene (PTFE), phenol formaldehyde (PF), epoxide (EP), polyurethane (PUR), and polyester (UP).

8. The air adsorbent for a micro speaker of claim 7, wherein the air adsorbent for a micro speaker has a thickness of 2.5 mm or less,
the metal-organic framework is dispersed and disposed inside and on a surface of the binder, and
the air adsorbent for a micro speaker is in the form of any one of a sheet, a film, and a block.

9. The air adsorbent for a micro speaker of claim 1, further comprising a matrix structure,
wherein the metal-organic framework is dispersed and disposed inside and outside the matrix structure.

10. The air adsorbent for a micro speaker of claim 9, wherein the metal-organic framework is disposed in the matrix structure through an impregnation process.

11. The air adsorbent for a micro speaker of claim 1, wherein the metal-organic framework is a zeolitic-imidazolate-framework.

12. A speaker box system comprising the air adsorbent for a micro speaker of claim 1.
